(19) United States
(12) Patent Application Publication
(10) Pub. No.: US 2024/0102813 A1
(43) Pub. Date: Mar. 28, 2024

(54) ROUTE DESIGN SYSTEM, COST FUNCTION LEARNING DEVICE, DESIGNED ROUTE OUTPUT DEVICE, METHOD, AND PROGRAM

(71) Applicant: NEC Corporation, Minato-ku, Tokyo (JP)

(72) Inventors: Asako Fujii, Tokyo (JP); Riki Eto, Tokyo (JP); Yuki Chiba, Tokyo (JP); Norihito Oi, Tokyo (JP)

(73) Assignee: NEC Corporation, Minato-ku, Tokyo (JP)

(21) Appl. No.: 18/273,664

(22) PCT Filed: Feb. 1, 2021
(86) PCT No.: PCT/JP2021/003514

§ 371 Date: Jul. 21, 2023

(51) Int. Cl. G01C 21/34; G06N 20/00

(52) U.S. Cl. CPC G01C 21/3453; G06N 20/00

(57) ABSTRACT

The function input means 71 accepts input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route. The learning means 72 learns the cost function by inverse reinforcement learning using training data that includes relay point information which is data that maps information indicating a relay point with surrounding information of the relay point and usage information of the relay point, and route result information which is result data of a route that pass through each relay point.

### TECHNICAL FIELD

This invention relates to a route design system and a route design method for designing a route via a relay point, a cost function learning device and a cost function learning program for learning a cost function to be used in designing a route, and a designed route output device, a designed route output method and a designed route output program for outputting a designed route.

### BACKGROUND ART

Various factors must be considered in designing routes, including transportation routes and networks for communication. For example, public transportation such as buses requires efficient route design that balances convenience for local residents with profitability. Existing routes also need to be reviewed periodically according to the development status of the region and the demographics of its residents.

Patent Literature 1 describes a bus route evaluation support system that supports decision-making for route restructuring and timetable revision based on quantitative evaluation results of bus routes. The system described in Patent Literature 1 creates multiple projects for evaluation and analysis for each route generation and performs evaluation and analysis individually.

### CITATION LIST

### Patent Literature

PTL 1: Japanese Patent Application Laid-Open No. 2011-164889

### SUMMARY OF INVENTION

### Technical Problem

For example, in the case of the bus routes described above, the reality is that the installation of new bus stops and route changes are considered and updated based on petitions from residents. In addition, the establishment of a bus stop is subject to various constraints, such as negotiations for the use of land for the bus stop, distance from curves, and so on. In addition, the route will need to be set up with an overall understanding of other transportation interests. Given these circumstances, it is difficult to manually review routes and bus stop locations on a frequent basis, and much know-how is required to coordinate routes.

By using the system described in Patent Literature 1, it is possible to individually evaluate the correlation between the evaluation data values and the target of analysis (e.g., within walking distance). However, the results evaluated by the system described in Patent Literature 1 show the factors to be considered individually. Therefore, in order to optimize the system as a whole, it requires a lot of know-how and a lot of time, as described above.

It is therefore an object of the present invention to provide a route design system and a route design method that can design high-quality routes quickly and efficiently, a cost function learning device and a cost function learning program for learning a cost function to be used for designing routes, and a designed route output device, a designed route output method and a designed route output program for outputting a designed route.

### Solution to Problem

The route design system according to the present invention includes a function input means which accepts input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, a learning means which learns the cost function by inverse reinforcement learning using training data that includes relay point information which is data that maps information indicating a relay point with surrounding information of the relay point and usage information of the relay point, and route result information which is result data of a route that pass through each relay point, a condition input means which accepts input of the relay point information for a network for which a new route design is to be performed, and a constraint condition, a relay point selection means which selects, based on the input relay point information, the candidate relay point with the minimum cost calculated by the cost function to satisfy the input constraint conditions, and a designed route output means which outputs the route with the minimum cost calculated by the cost function among routes that pass through some or all of the relay points in the network to satisfy the constraint conditions.

The cost function learning device according to the present invention includes a function input means which accepts input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, and a learning means which learns the cost function by inverse reinforcement learning using training data that includes relay point information which is data that maps information indicating a relay point with surrounding information of the relay point and usage information of the relay point, and route result information which is result data of a route that pass through each relay point.

The designed route output device according to the present invention includes a condition input means which accepts input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition, a relay point selection means which selects, based on the input relay point information, the candidate relay point with the minimum cost calculated by the cost function to satisfy the input constraint conditions, and a designed route output means which outputs the route with the minimum cost calculated by the cost function among routes that pass through some or all of the relay points in the network to satisfy the constraint conditions, wherein the condition input means accepts input of the cost function learned by inverse reinforcement learning using training data that includes the relay point information and route result information which is result data of a route that pass through each relay point.

The route design method according to the present invention includes: accepting input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route; and a learning means which learns the cost function by inverse reinforcement learning using training data that includes relay point information which is data that maps information indicating a relay point with surrounding information of the relay point and usage information of the relay point, and route result information which is result data of a route that pass through each relay point.

The designed route output method according to the present invention includes: accepting input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition; selecting, based on the input relay point information, the candidate relay point with the minimum cost calculated by the cost function to satisfy the input constraint conditions; and outputting the route with the minimum cost calculated by the cost function among routes that pass through some or all of the relay points in the network to satisfy the constraint conditions, wherein, when entering conditions, input of the cost function learned by inverse reinforcement learning using training data that includes the relay point information and route result information which is result data of a route that pass through each relay point is accepted.

The cost function learning program according to the present invention causes a computer to execute: function input processing to accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route; and learning processing to learn the cost function by inverse reinforcement learning using training data that includes relay point information which is data that maps information indicating a relay point with surrounding information of the relay point and usage information of the relay point, and route result information which is result data of a route that pass through each relay point.

The designed route output program according to the present invention causes a computer to execute: condition input processing to accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition; relay point selection processing to select, based on the input relay point information, the candidate relay point with the minimum cost calculated by the cost function to satisfy the input constraint conditions; and designed route output processing to output the route with the minimum cost calculated by the cost function among routes that pass through some or all of the relay points in the network to satisfy the constraint conditions, wherein, in the condition input processing, input of the cost function learned by inverse reinforcement learning using training data that includes the relay point information and route result information which is result data of a route that pass through each relay point is accepted.

### Advantageous Effects of Invention

According to the invention, high-quality routes can be designed quickly and efficiently.

### BRIEF DESCRIPTION OF DRAWINGS

FIG. 1 It depicts a block diagram showing a configuration example of an exemplary embodiment of a route design system according to the present invention.

FIG. 2 It depicts an explanatory diagram showing an example of route design data.

FIG. 3 It depicts an explanatory diagram showing an example of the process of updating a route.

FIG. 4 It depicts a flowchart showing an example of the operation of a learning device.

FIG. 5 It depicts a flowchart showing an example of the operation of a designed route output device.

FIG. 6 It depicts a block diagram showing a modified example of a route design system.

FIG. 7 It depicts an explanatory diagram showing an example of the process of designing a new route.

FIG. 8 It depicts a block diagram showing an overview of the route design system according to the present invention.

FIG. 9 It depicts a block diagram showing an overview of the cost function learning device according to the present invention.

FIG. 10 It depicts a block diagram showing an overview of the designed route output device according to the present invention.

### DESCRIPTION OF EMBODIMENTS

The route design system is a system for designing routes via relay points (e.g., bus stops and relay devices) in various networks such as road networks and communication networks. In the following description, for simplicity of explanation, the case of designing a bus route via a bus stop, which is a relay point in a road network, is explained. However, the routes designed by the route design system are not limited to bus routes. For example, the route design system of the present invention can also be applied to situations where trains, boats, airplanes, network routing, etc. are designed.

Hereinafter, exemplary embodiments of the present invention will be described with reference to the drawings.

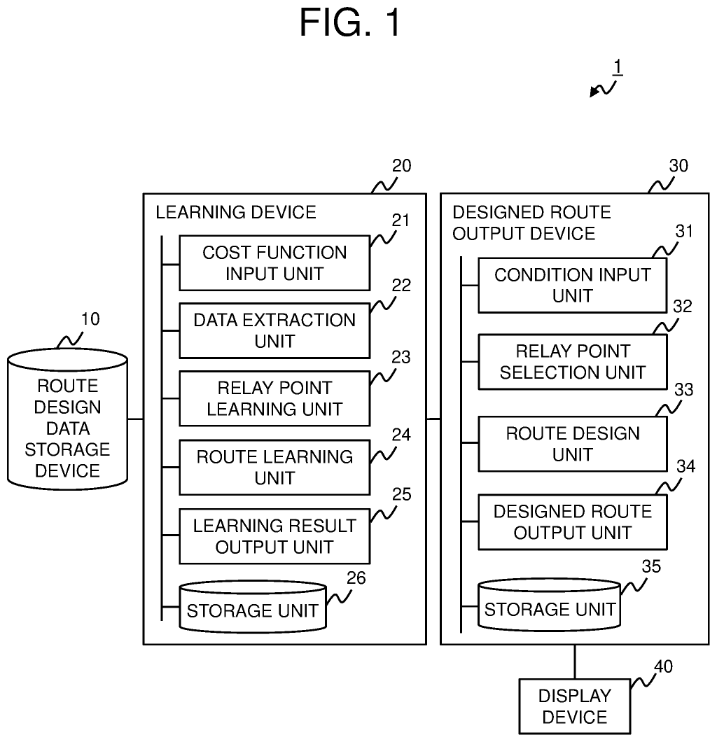

FIG. 1 is a block diagram showing a configuration example of an exemplary embodiment of a route design system according to the present invention. The route design system 1 in this exemplary embodiment includes a route design data storage device 10, a learning device 20, a designed route output device 30, and a display device 40.

The display device 40 is a device that outputs the results of various processes by the route design system 1. The display device 40 is realized, for example, by a display device. Although FIG. 1 shows an example of one display device 40 connected to the designed route output device 30, the display device 40 connected to the learning device 20 and the display device 40 connected to the designed route output device 30 may be provided separately.

The route design data storage device 10 stores data related to routes designed in the past (hereinafter referred to as “route design data”). Specifically, the route design data is data including data that maps information indicating a relay point with surrounding information (e.g., distance to neighboring relay points, existence of department stores) of the relay point and usage information (e.g., the number of users of transportation, the number of packets passing through, information indicating whether it is newly built or not) of the relay point (hereinafter referred to as “relay point information”), and result data of a route that pass through each relay point (hereinafter referred to as route result information).

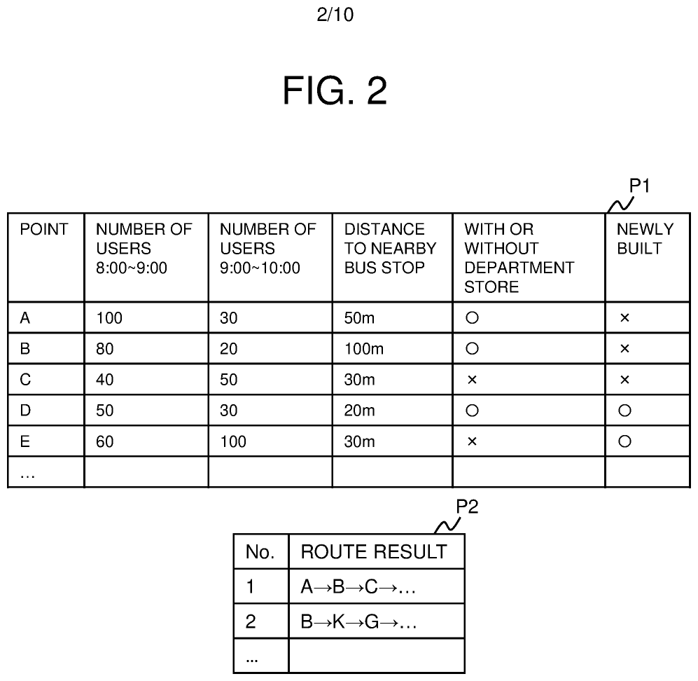

FIG. 2 is an explanatory diagram showing an example of route design data. The route design data illustrated in FIG. 2 includes relay point information P1, which indicates the number of users at each relay point by time of day, the distance to nearby bus stops, whether or not there are department stores around the relay point, and whether or not the relay point is newly built, and route result information P2, which indicates the actual past routes connecting these relay points.

The route design data illustrated in FIG. 2 is information obtained when designing a route that is already in operation, and can be said to be data prepared by an expert, since it is data prepared by a skilled person taking various factors into consideration. The relay point information and route result information illustrated in FIG. 2 are examples, respectively, and may include other information. Other information may include, for example, population density by area, building information, difficulty in setting relay points, and information on surrounding roads. These specific details are described below.

The learning device 20 includes a cost function input unit 21, a data extraction unit 22, a relay point learning unit 23, a route learning unit 24, a learning result output unit 25, and a storage unit 26.

The cost function input unit 21 accepts input of a cost function used for learning by the relay point learning unit 23 and the route learning unit 24 described below. Specifically, the cost function input unit 21 accepts input of a cost function to calculate a cost incurred in selecting candidate relay points (hereinafter referred to as the first cost function) and a cost function that calculates a cost incurred in designing a route (hereinafter referred to as the second cost function).

The cost function input unit 21 may accept the input of one type of cost function instead of two types of cost functions, the first cost function and the second cost function. Features that are less relevant to the selection of relay points and route design are set to have lower weights as a result of the machine learning described below, resulting in the extraction of features intended by the expert in the selection of relay points and route design.

The cost function is represented as a linear sum of terms weighted by degree of importance attached to each of the features that an expert is assumed to intend when selecting the candidate relay point and design of the route, such as those included in the route design data illustrated in FIG. 2. The degree of importance can be said to represent the intention of the expert in designing the route. Therefore, the value calculated by the cost function can be said to be an evaluation index used for selecting relay points and evaluating route design.

The cost function input unit 21 may also accept input of constraint conditions to be satisfied along with the cost function. The cost function and constraint conditions are predetermined by the designer or others. That is, candidates of features to be considered in selecting relay points and designing routes are selected in advance by analysts, etc. and defined as the cost function. The cost function input unit 21 may, for example, accept input of the cost function that includes at least one of the number of users and satisfaction level as the feature.

More specifically, when the number of users in each time period and whether the relay point is newly built or not are considered as items (features) intended by the expert, the cost function is represented by Equation 1, which is illustrated below. In Equation 1, xᵢⱼ and yᵢ represent features, and α and β represent weights (degree of importance). Specifically, xᵢⱼ indicates the number of users during time period j at relay point i, and yᵢ indicates whether or not relay point i is a newly built point.

[Math. 1]

cost function=Σᵢⱼαxᵢⱼ+βyᵢ+(Equation 1)

By using changes with time as shown above (e.g., number of users from 6:00 to 8:00, number of users from 8:00 to 10:00, etc.) as the feature, it is also possible to generate routes fluidly and automatically.

The features shown above are examples, and the cost function may include other features. For example, other features include population density by area. For example, the cost incurred in setting up a relay point is calculated to be lower when the population is higher, because a larger population has more users. On the other hand, a smaller population is more useful as a niche route, so, for example, the cost incurred in designing a route is calculated lower for a smaller population.

Another feature includes building information (presence/absence). Since the presence of buildings such as stations, hospitals, convenience stores and supermarkets attract a large flow of people, the more these buildings are present, the lower the cost is calculated. Another feature includes the slope of the road. The higher the slope of the road, the higher the cost is calculated, since a higher slope leads to lower visibility and speed. Other features may include the surrounding natural environment, the presence or absence of temples, and whether the land is public land or not.

Features indicative of weather and seasonal winds may also be used when designing airplane routes.

The data extraction unit 22 extracts route design data from the route design data storage device 10 for the range for which the route is to be designed. The range for which a route is to be designed is specified in advance by the designer or others. The extracted route design data is used for learning by the relay point learning unit 23 and the route learning unit 24 described below, so the extracted route design data is sometimes referred to as training data.

The data extraction unit 22 may also perform processes to convert items in the route design data to features (e.g., arithmetic operations, conversion to binary values, etc.), data integration, data cleansing, etc., in order to match the features included in the cost function.

The relay point learning unit 23 learns the cost function (specifically, the first cost function) described above by inverse reinforcement learning using the training data extracted by the data extraction unit 22.

The method by which the relay point learning unit 23 performs inverse reinforcement learning is arbitrary. For example, the relay point learning unit 23 may learn the cost function, for example, by repeating the mathematical optimization process to select relay points based on the input cost function and constraints, and the cost function estimation process that updates the parameters of the cost function (degree of importance) to reduce the difference between the generated expert's intended relay point and the training data.

The relay point learning unit 23 learns the cost function by inverse reinforcement learning using the route design data, which makes it possible to extract the intended feature when selecting relay points.

The route learning unit 24 learns the cost function (specifically, the second cost function) described above by inverse reinforcement learning using the training data extracted by the data extraction unit 22.

The method by which the route learning unit 24 performs inverse reinforcement learning is also arbitrary. For example, the route learning unit 24 may learn the cost function, for example, by repeating the mathematical optimization process to design a route based on the input cost function and constraints, and the cost function estimation process that updates the parameters of the cost function (degree of importance) to reduce the difference between the designed expert's intended route and the training data.

The route learning unit 24 learns the cost function by inverse reinforcement learning using the route design data, which makes it possible to extract the features that are intended when designing the route.

The relay point learning unit 23 and the route learning unit 24 may be configured as a single learning means. That is, the learning means may include the relay point learning unit 23 and the route learning unit 24. In this case, the learning means may learn the cost function by inverse reinforcement learning using training data.

The learning result output unit 25 outputs the learned cost functions. Specifically, the learning result output unit 25 outputs the features included in the cost function (more specifically, the first cost function and the second cost function) in correspondence with the weights of the features. The learning result output unit 25 may store the learned cost functions in the storage unit 26, or may transmit information of the cost function to the designed route output device 30 for storage in the storage unit 35.

The learning result output unit 25 may also display the contents of the cost function on the display device 40. Displaying the contents of the cost function on the display device 40 enables experts to see the items that are important in selecting relay points and designing routes.

The storage unit 26 stores the learned cost function. The storage unit 26 may also store various parameters used by the relay point learning unit 23 and the route learning unit 24 for inverse reinforcement learning. The storage unit 26 is realized by, for example, a magnetic disk.

The cost function input unit 21, the data extraction unit 22, the relay point learning unit 23, the route learning unit 24, and learning result output unit 25 are implemented by a processor (for example, a central processing unit (CPU)) of a computer that operates according to a program (learning program, route design program).

For example, the program may be stored in the storage unit 26 of the learning device 20, and the processor may read the program and operate as the cost function input unit 21, data extraction unit 22, relay point learning unit 23, route learning unit 24, and learning result output unit 25 according to the program. Furthermore, the function of the learning device 20 may be provided in a software as a service (SaaS) format.

The cost function input unit 21, the data extraction unit 22, the relay point learning unit 23, the route learning unit 24, and learning result output unit 25 may be implemented by dedicated hardware. In addition, some or all of the components of each device may be implemented by general-purpose or dedicated circuitry, a processor, or the like, or a combination thereof. These may be configured by a single chip or may be configured by a plurality of chips connected via a bus. Some or all of the components of each device may be implemented by a combination of the above-described circuit or the like and a program.

In addition, in a case where some or all of the components of the learning device 20 are implemented by a plurality of information processing devices, circuits, and the like, the plurality of information processing devices, circuits, and the like may be disposed in a centralized manner or in a distributed manner. For example, the information processing device, the circuit, and the like may be implemented as a mode in which the same are connected to each other via a communication network such as a client server system and a cloud computing system.

The learning device 20 may learn multiple cost functions. For example, the learning device 20 may learn multiple cost functions using past result (training data) in multiple districts (District A, District B, etc.).

The designed route output device 30 includes a condition input unit 31, a relay point selection unit 32, a route design unit 33, a designed route output unit 34, and a storage unit 35.

The storage unit 35 stores various information used by the relay point selection unit 32 (described below) to select candidate relay points, and by the route design unit 33 to design routes. The storage unit 35 also stores other related information, such as map information of the target area, locations that are candidates for relay points in that area, building information around those relay points, and demographic information. The storage unit 35 may also store a cost function learned by the learning device 20. The storage unit 35 is realized by, for example, a magnetic disk.

The condition input unit 31 accepts input of relay point information for a network for which a new route design is to be performed, as well as constraint conditions for selecting candidate relay points and for designing a route. The condition input section 31 may accept input of conditions indicating, for example, legal restrictions (e.g., bus stops cannot be located at sharp curves, bus stops cannot be located within 10 meters of sidewalks, etc.) or restrictions based on conflicts with other transportations (e.g., bus stops cannot be located near other existing bus stops, etc.) as constraints for selecting candidate relay points. The condition input unit 31 may also accept input of conditions indicating, for example, start point and finish point conditions or transportation network constraints (e.g., one-way traffic) as constraints when designing the route.

Since the learned cost function is assumed to reflect the intention of the expert, it is assumed that the selection of candidate relay points that would violate the constraint and the design of routes that would violate the constraint are implicitly suppressed, even without explicit constraint input. For example, if a bus stop has never been located closer than 10 meters from a sidewalk in the past, it is assumed that the learned cost function will make it less likely that a choice will be made to locate closer than 10 meters from the sidewalk.

Furthermore, the condition input unit 31 accepts the input of the surrounding information of the relay points and the use information of the relay points for the network for which the route is to be newly designed, in addition to the input of the constraint conditions. Specifically, the condition input unit 31 may accept input of relevant information when designing a route. For example, when regional information is updated when designing a bus route, the condition input unit 31 may accept inputs of regional information such as population density by area, building (store) information, redevelopment information, etc. as information surrounding the relay point that indicates the latest status of that area. If the cost function takes into account travel history by other transportation modes (e.g., cab driving records), the condition input unit 31 may accept input of such travel history.

The condition input unit 31 may accept, as a constraint condition, input of a list of relay points that are candidates to be selected by the relay point selection unit 32 described below. The condition input unit 31 may also accept, as a constraint condition, input of information indicating a range within the network for which the relay point selection unit 32 (described below) can set relay points.

When the cost function is not stored in storage unit 35, the condition input unit 31 may accept input of the cost function.

The relay point selection unit 32 selects, based on the input relay point information, the candidate relay point with the minimum cost calculated by the cost function (more specifically, the first cost function) to satisfy the input constraint condition. The list of candidate relay points to be selected may be predetermined by the designer or others. In other words, the relay point selection unit 32 may select the candidate relay point from the list of candidate relay points. When the range in the network where the relay points can be set is input as a constraint condition, the relay point selection unit 32 may select the candidate relay point from the input range in the network.

The relay point selection unit 32 may select multiple candidate relay points by repeating the process of excluding the selected candidate relay points and selecting more candidate relay points a predetermined number of times.

The route design unit 33 designs a route with the minimum cost calculated by the cost function (more specifically, the second cost function) among routes that pass through some or all of the selected relay points in the network to satisfy the input constraint conditions. The route to be designed need not be a route via all the selected candidate relay points. The route design unit 33 may also design a route including existing relay points in addition to the relay points selected by the relay point selection unit 32.

Specifically, the route design unit 33 may design a route by seeking a combination of relay points that minimizes a total cost based on the cost incurred when moving from a candidate relay point selected by the relay point selection unit 32 to another candidate relay point.

The method by which the route design unit 33 seeks a combination of routes that minimizes the total cost is arbitrary. The route design unit 33 may design the routes as a combinatorial optimization problem. For example, the route design unit 33 may design a route as a problem of solving for the route that minimizes the cost using the cost calculated by the cost function instead of the distance used in the Dijkstra method algorithm.

The designed route output unit 34 outputs the designed route. For example, when designing a bus route, the designed route output unit 34 may output the bus travel route connecting the output point and the arrival point, which is the route, and the location of stops, which are relay points.

The designed route output unit 34 may also output together with the proposed design of the new route, the projected number of users, the projected profitability, and so on. Furthermore, the designed route output unit 34 may output each relay point included in the designed route and the route connecting those relay points superimposed on a map. This makes it possible to grasp the designed route more concretely.

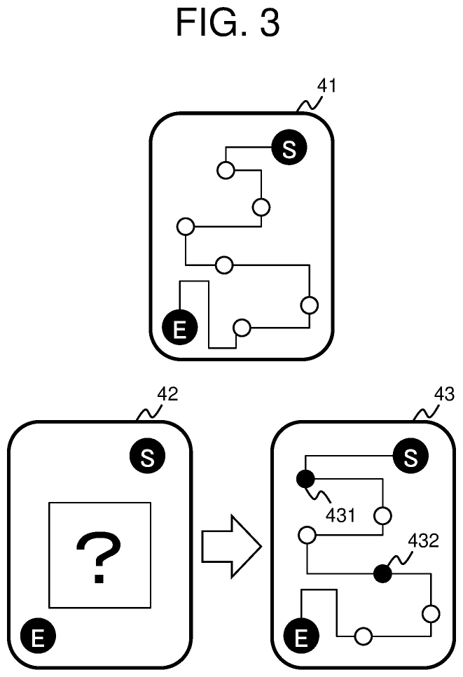

FIG. 3 is an explanatory diagram showing an example of the process of updating a route. For example, it is assumed that information indicating past route data 41 is stored in the route design data storage device 10 as route design data. The route design data includes, for example, population density by area, building (store) information, redevelopment information, and road information at the time of design. The route design data storage device 10 may also store the number of customers and profitability of the route indicated by the historical route data 41, as well as the constraints that were used when the historical route data 41 was designed.

Based on this information, the relay point learning unit 23 and the route learning unit 24 learn a model (i.e., a cost function) that shows what policies were used to create high-quality routes (successful routes) that were manually designed in the past.

Next, the condition input unit 31 accepts input of constraint conditions. The example shown in FIG. 3 indicates that the start and goal points are specified as constraint conditions 42. The condition input unit 31 may also accept input of updated regional information as other constraint conditions (related information).

The relay point selection unit 32 selects candidate relay points from the input constraint conditions and related information. The route design unit 33 designs a new route based on the input constraint conditions and related information. The example shown in FIG. 3 indicates that a new route 43 via new relay point 431 and relay point 432 is designed. The designed route output unit 34 then outputs the designed route 43. The designed route output unit 34 may also output the projected number of users and projected profitability along with the route 43.

The condition input unit 31, the relay point selection unit 32, the route design unit 33, and the designed route output unit 34 are realized by a computer processor (e.g., CPU) that operates according to a program (design route output program, route design program).

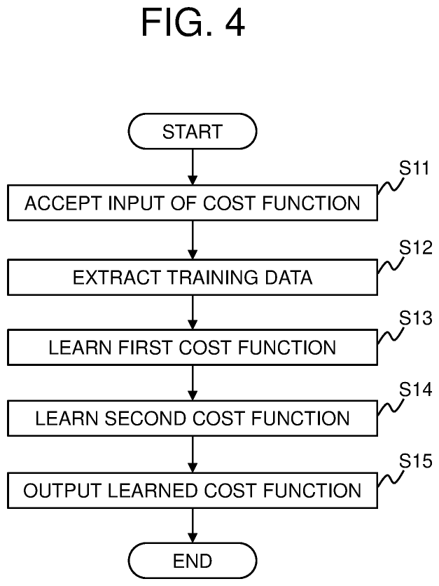

Next, the operation of this exemplary embodiment of route design system is described. FIG. 4 is a flowchart showing an example of the operation of a learning device 20 in this exemplary embodiment. The cost function input unit 21 accepts input of a cost function (step S11). The cost function input unit 21 may accept inputs for two types of cost functions (first cost function and second cost function). The data extraction unit 22 extracts training data from the route design data storage device 10 (step S12). The relay point learning unit 23 learns the first cost function that calculates the cost incurred in selecting candidate relay points by inverse reinforcement learning using the training data (step S13). The route learning unit 24 also learns the second cost function that calculates the cost incurred in designing a route by inverse reinforcement learning using training data (step S14). The learning result output unit 25 outputs the learned cost function (step S15).

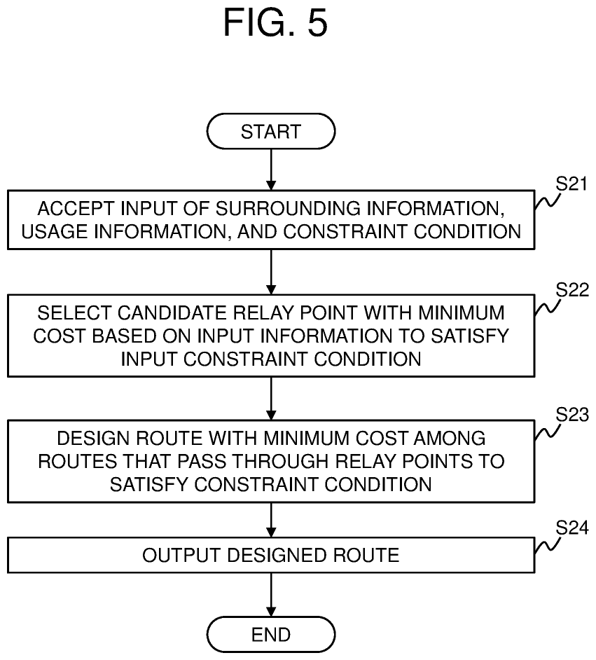

FIG. 5 is a flowchart showing an example of the operation of a designed route output device 30 in this exemplary embodiment. The condition input unit 31 accepts input of surrounding information and usage information for a network for which a new route design is to be performed, and a constraint condition (step S21). The relay point selection unit 32 selects a candidate relay point with the minimum cost calculated by the cost function based on the input surrounding information and the usage information of the relay point to satisfy the input constraint condition (step S22). The route design unit 33 designs the route with the minimum cost calculated by the cost function among routes that pass through some or all of the relay points in the network to satisfy the constraint condition (step S23). Then, the designed route output unit 34 outputs the designed route (step S24).

As described above, in this exemplary embodiment, the cost function input unit 21 accepts input of the cost function, and the relay point learning unit 23 and route learning unit 24 learn the cost function by inverse reinforcement learning using training data. The condition input unit 31 accepts inputs of surrounding information and usage information for a network for which a new route design is to be performed, and a constraint condition, and the relay point selection unit 32 selects a candidate relay point with the minimum cost calculated by the cost function to satisfy the input constraint condition. Then, the route design unit 33 designs the route with the minimum cost calculated by the cost function among routes that pass through some or all of the relay points in the network to satisfy the constraint condition, and the designed route output unit 34 outputs the designed route. In this way, routes designed by so-called expert can be said to be of high quality, and thus high-quality route design can be performed quickly and efficiently.

In other words, in this exemplary embodiment, inverse reinforcement learning is used to learn route designs that are recognized as satisfying the constraints from past route design data, and the resulting route design model is used to update routes or design new routes. Thus, public transportation route design can be achieved without relying on human labor, allowing for efficient and high-quality route updates and designs on a regular basis.

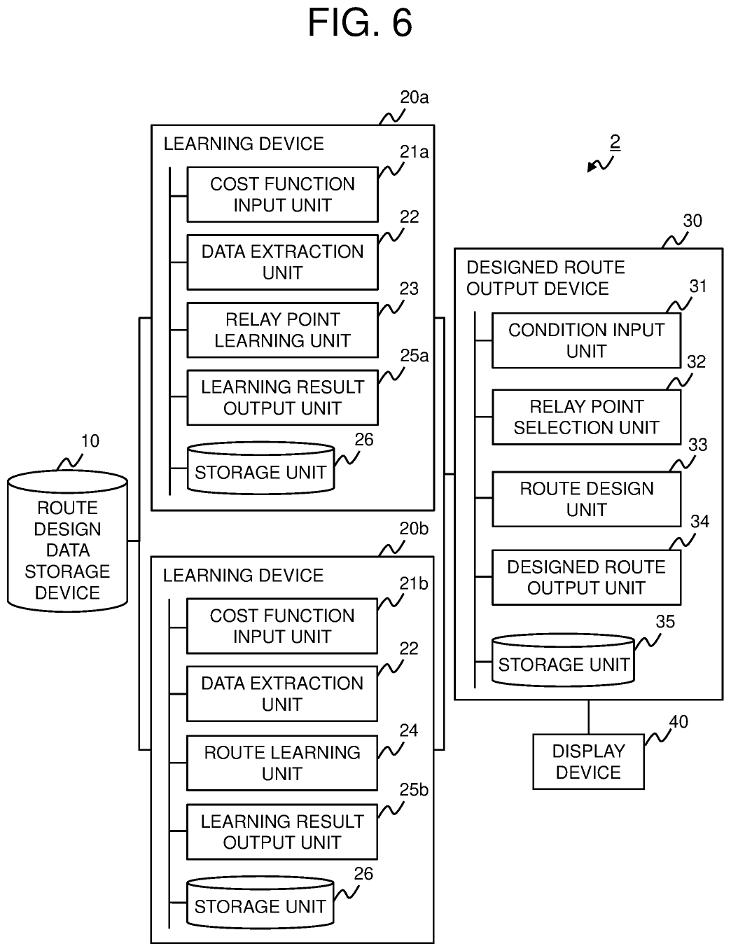

Next, a modified example of a route design system in this exemplary embodiment is described. FIG. 6 is a block diagram showing a modified example of a route design system in this exemplary embodiment. The route design system 2 illustrated in FIG. 6 includes a route design data storage device 10, a learning device 20a, a learning device 20b, a designed route output device 30, and a display device 40. The contents of the route design data storage device 10, the designed route output device 30, and the display device 40 are the same as in the above exemplary embodiment.

The learning device 20a is a device for learning the first cost function. The learning device 20a includes a cost function input unit 21a, a data extraction unit 22, a relay point learning unit 23, a learning result output unit 25a, and a storage unit 26. The contents of the data extraction unit 22, relay point learning unit 23, and storage unit 26 are the same as in the above exemplary embodiment.

The cost function input unit 21a accepts the input of the first cost function as the cost function used for learning. Otherwise, it is the same as the cost function input unit 21. The learning result output unit 25a outputs the learned first cost function. Otherwise, it is the same as the learning result output unit 25.

The learning device 20b is a device for learning the second cost function. The learning device 20b includes a cost function input unit 21b, a data extraction unit 22, a route learning unit 24, a learning result output unit 25b, and a storage unit 26. The contents of the data extraction unit 22, the route learning unit 24, and the storage unit 26 are the same as in the above exemplary embodiment.

The cost function input unit 21b accepts the input of the second cost function as the cost function used for learning. Otherwise, it is the same as the cost function input unit 21. The learning result output unit 25b outputs the learned second cost function. Otherwise, it is the same as the learning result output unit 25.

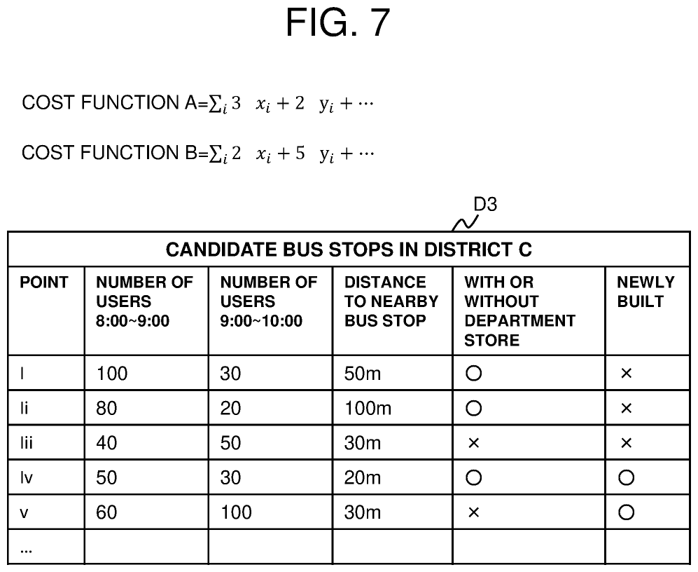

The following is an explanation of the operation of the route design system 1 using specific examples. FIG. 7 is an explanatory diagram showing an example of the process of designing a new route. In this specific example, it is assumed that two types of cost functions are learned by the learning device 20 of this exemplary embodiment using training data in different districts.

Specifically, it is assumed that the cost function A illustrated in FIG. 7 was learned using the past results in District A and the cost function B illustrated in FIG. 7 was learned using the past results in District B. Additionally, it is assumed that x, is a feature indicating the number of users at relay point i and y, is a feature indicating whether or not relay point i is a newly built point. Since the content of the cost function is represented here as a reward, it is assumed that the relay point selection unit 32 selects the relay point with the largest reward.

Under these circumstances, it is assumed that a bus route in a new district C with a candidate bus stop D3, as illustrated in FIG. 7, is planned. Since cost function A and cost function B have been learned by the learning device 20 in this exemplary embodiment, the weighting of the features corresponds to the degree of importance. Here, when trying to design a route with a large profit (in other words, to increase the number of users), a cost function with a large coefficient of x, is a cost function intended to increase the profit. Therefore, it is determined that the route is designed using the cost function A.

Assuming the bus stop candidate D3 illustrated in FIG. 7, the cost function A can be maximized by adopting the relay points (bus stops) indicated by points (i), (iv) and (v) as new routes.

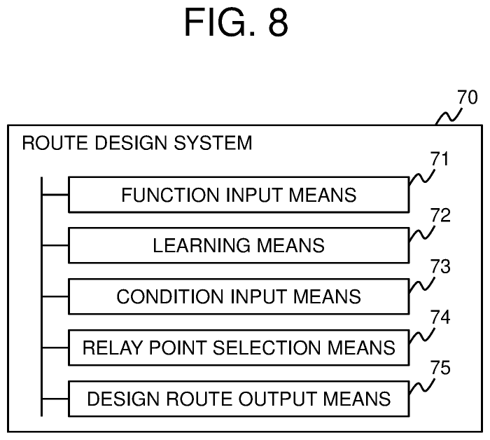

The following is an overview of the invention. FIG. 8 is a block diagram showing an overview of the route design system according to the present invention. The route design system 70 (e.g., route design system 1) according to the present invention includes a function input means 71 (e.g., cost function input unit 21) which accepts input of a cost function that calculates a cost incurred in at least one of a selection of a candidate relay point (e.g., bus stops) and a design of a route (e.g., routes), the cost function being represented as a linear sum of terms weighted by degree of importance attached to each of the features that an expert is assumed to intend when selecting the candidate relay point and design of the route, a learning means 72 (e.g., relay point learning unit 23, route learning unit 24) which learns the cost function (e.g., first cost function and second cost function) by inverse reinforcement learning using training data that includes relay point information which is data that maps information indicating a relay point with surrounding information of the relay point and usage information of the relay point, and route result information which is result data of a route that pass through each relay point, a condition input means 73 (e.g., condition input unit 31) which accepts input of the relay point information for a network for which a new route design is to be performed, and a constraint condition, a relay point selection means 74 (e.g., relay point selection unit 32) which selects, based on the input relay point information, the candidate relay point with the minimum cost calculated by the cost function to satisfy the input constraint conditions, and a designed route output means 75 (e.g., route design unit 33, designed route output unit 34) which outputs the route with the minimum cost calculated by the cost function among routes that pass through some or all of the relay points in the network to satisfy the constraint conditions.

Such a configuration can design high-quality routes quickly and efficiently.

Specifically, the designed route output means 73 may output the route designed by seeking a combination of relay points that minimizes a total cost based on the cost incurred when moving from one candidate relay point to another candidate relay point.

The learning means may include a relay point learning means (e.g., relay point learning unit 23) which learns a first cost function which is a cost function that calculates a cost incurred in selecting the candidate relay point, and a route learning means (route learning unit 24) which learns a second cost function which is a cost function that calculates a cost incurred in designing a route. Then, the relay point selection means 74 may select a candidate relay point with the minimum cost calculated by the first cost function, and the designed route output means 75 may output the route with the minimum cost calculated by the second cost function.

The condition input means 73 may accept input of a list of relay points that are candidates to be selected as constraint conditions, and the relay point selection means 74 may select the candidate relay point from the received list.

The condition input means 73 may accept input of information indicating a range of a network where the relay point can be set as a constraint condition, and the relay point selection means 74 may select the candidate relay point from the range of the network which is input.

The designed route output means 75 may output each relay point included in the designed route and the route connecting each the relay point superimposed on a map.

The route design system 70 may also include a learning result output means (e.g., learning result output unit 25) which outputs a correspondence between a feature included in the cost function and the degree of importance of the feature.

The learning means 72 may learn the cost function that includes at least one of the number of users and satisfaction level as a feature.

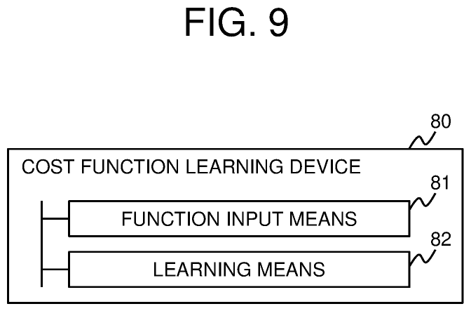

FIG. 9 is a block diagram showing an overview of the cost function learning device according to the present invention. The cost function learning device 80 (e.g., learning device 20) according to the present invention includes a function input means 81, and a learning means 82. The contents of the function input means 81, and the learning means 82 are similar to the function input means 71, and the learning means 72 illustrated in FIG. 8.

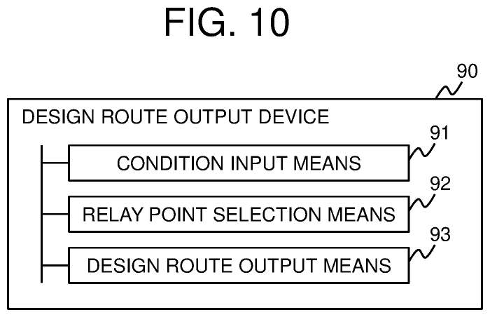

FIG. 10 is a block diagram showing an overview of the designed route output device according to the present invention. The design route output device 90 (e.g., designed route output device 30) according to the present invention includes a condition input means 91, a relay point selection means 92, and a design route output means 93. The contents of the condition input means 91, the relay point selection means 92, and the design route output means 93 are similar to the condition input means 73, the relay point selection means 74, and the design route output means 75 illustrated in FIG. 8.

Some or all of the aforementioned exemplary embodiment can be described as supplementary notes mentioned below, but are not limited to the following supplementary notes.

(Supplementary note 1) A route design system comprising:
a function input means which accepts input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route;
a learning means which learns the cost function by inverse reinforcement learning using training data that includes relay point information which is data that maps information indicating a relay point with surrounding information of the relay point and usage information of the relay point, and route result information which is result data of a route that pass through each relay point;
a condition input means which accepts input of the relay point information for a network for which a new route design is to be performed, and a constraint condition;
a relay point selection means which selects, based on the input relay point information, the candidate relay point with the minimum cost calculated by the cost function to satisfy the input constraint conditions; and
a designed route output means which outputs the route with the minimum cost calculated by the cost function among routes that pass through some or all of the relay points in the network to satisfy the constraint conditions.

(Supplementary note 2) The route design system according to Supplementary note 1, wherein
the designed route output means outputs the route designed by seeking a combination of relay points that minimizes a total cost based on the cost incurred when moving from one candidate relay point to another candidate relay point.

(Supplementary note 3) The route design system according to Supplementary note 1 or 2, wherein
the learning means includes:
a relay point learning means which learns a first cost function which is a cost function that calculates a cost incurred in selecting the candidate relay point; and
a route learning means which learns a second cost function which is a cost function that calculates a cost incurred in designing a route,
wherein the relay point selection means selects a candidate relay point with the minimum cost calculated by the first cost function, and
the designed route output means outputs the route with the minimum cost calculated by the second cost function.

(Supplementary note 4) The route design system according to any one of Supplementary notes 1 to 3, wherein
the condition input means accepts input of a list of relay points that are candidates to be selected as constraint conditions, and
the relay point selection means selects the candidate relay point from the received list.

(Supplementary note 5) The route design system according to any one of Supplementary notes 1 to 4, wherein
the condition input means accepts input of information indicating a range of a network where the relay point can be set as a constraint condition, and
the relay point selection means selects the candidate relay point from the range of the network which is input.

(Supplementary note 6) The route design system according to any one of Supplementary notes 1 to 5, wherein
the designed route output means outputs each relay point included in the designed route and the route connecting each the relay point superimposed on a map.

(Supplementary note 7) The route design system according to any one of Supplementary notes 1 to 6, further comprising
a learning result output means which outputs a correspondence between a feature included in the cost function and the degree of importance of the feature.

(Supplementary note 8) The route design system according to any one of Supplementary notes 1 to 7, wherein
the learning means learns the cost function that includes at least one of the number of users and satisfaction level as a feature.

(Supplementary note 9) A cost function learning device comprising:
a function input means which accepts input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route; and
a learning means which learns the cost function by inverse reinforcement learning using training data that includes relay point information which is data that maps information indicating a relay point with surrounding information of the relay point and usage information of the relay point, and route result information which is result data of a route that pass through each relay point.

(Supplementary note 10) A designed route output device comprising:
a condition input means which accepts input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition;
a relay point selection means which selects, based on the input relay point information, the candidate relay point with the minimum cost calculated by the cost function to satisfy the input constraint conditions; and
a designed route output means which outputs the route with the minimum cost calculated by the cost function among routes that pass through some or all of the relay points in the network to satisfy the constraint conditions;
wherein the condition input means accepts input of the cost function learned by inverse reinforcement learning using training data that includes the relay point information and route result information which is result data of a route that pass through each relay point.

(Supplementary note 11) A route design method comprising:
accepting input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route; and
a learning means which learns the cost function by inverse reinforcement learning using training data that includes relay point information which is data that maps information indicating a relay point with surrounding information of the relay point and usage information of the relay point, and route result information which is result data of a route that pass through each relay point.

(Supplementary note 12) A route design method according to Supplementary note 11, further comprising:
accepting input of the relay point information for a network for which a new route design is to be performed, and a constraint condition;
selecting, based on the input relay point information, the candidate relay point with the minimum cost calculated by the cost function to satisfy the input constraint conditions; and
outputting the route with the minimum cost calculated by the cost function among routes that pass through some or all of the relay points in the network to satisfy the constraint conditions.

(Supplementary note 13) A designed route output method comprising:
accepting input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition;
selecting, based on the input relay point information, the candidate relay point with the minimum cost calculated by the cost function to satisfy the input constraint conditions; and
outputting the route with the minimum cost calculated by the cost function among routes that pass through some or all of the relay points in the network to satisfy the constraint conditions;
wherein, when entering conditions, input of the cost function learned by inverse reinforcement learning using training data that includes the relay point information and route result information which is result data of a route that pass through each relay point is accepted.

(Supplementary note 14) A program storage medium storing a cost function learning program for causing a computer to execute:
function input processing to accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route; and
learning processing to learn the cost function by inverse reinforcement learning using training data that includes relay point information which is data that maps information indicating a relay point with surrounding information of the relay point and usage information of the relay point, and route result information which is result data of a route that pass through each relay point.

(Supplementary note 15) A program storage medium storing a designed route output program for causing a computer to execute:
condition input processing to accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition;
relay point selection processing to select, based on the input relay point information, the candidate relay point with the minimum cost calculated by the cost function to satisfy the input constraint conditions; and
designed route output processing to output the route with the minimum cost calculated by the cost function among routes that pass through some or all of the relay points in the network to satisfy the constraint conditions;
wherein, in the condition input processing, input of the cost function learned by inverse reinforcement learning using training data that includes the relay point information and route result information which is result data of a route that pass through each relay point is accepted.

(Supplementary note 16) A cost function learning program for causing a computer to execute:
function input processing to accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route; and
learning processing to learn the cost function by inverse reinforcement learning using training data that includes relay point information which is data that maps information indicating a relay point with surrounding information of the relay point and usage information of the relay point, and route result information which is result data of a route that pass through each relay point.

(Supplementary note 17) A designed route output program for causing a computer to execute:
condition input processing to accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition;
relay point selection processing to select, based on the input relay point information, the candidate relay point with the minimum cost calculated by the cost function to satisfy the input constraint conditions; and
designed route output processing to output the route with the minimum cost calculated by the cost function among routes that pass through some or all of the relay points in the network to satisfy the constraint conditions;
wherein, in the condition input processing, input of the cost function learned by inverse reinforcement learning using training data that includes the relay point information and route result information which is result data of a route that pass through each relay point is accepted.

While the present invention has been explained with reference to the exemplary embodiments, the present invention is not limited to the aforementioned exemplary embodiments. Various changes understandable to those skilled in the art within the scope of the present invention can be made to the structures and details of the present invention.

### REFERENCE SIGNS LIST

1, 2 Route design system
10 Route design data storage device
20, 20a, 20b Learning device
21, 21a, 21b Cost function input unit
22 Data extraction unit
23 Relay point learning unit
24 Route learning unit
25, 25a, 25b Learning result output unit
26 Storage unit
30 Designed route output device
31 Condition input unit
32 Relay point selection unit
33 Route design unit
34 Designed route output unit
35 Storage unit
40 Display device

What is claimed is:

1. A route design system comprising:
a memory storing instructions; and
one or more processors configured to execute the instructions to:
accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route;
learn the cost function by inverse reinforcement learning using training data that includes relay point information which is data that maps information indicating a relay point with surrounding information of the relay point and usage information of the relay point, and route result information which is result data of a route that pass through each relay point;
accept input of the relay point information for a network for which a new route design is to be performed, and a constraint condition;
select, based on the input relay point information, the candidate relay point with the minimum cost calculated by the cost function to satisfy the input constraint conditions; and
output the route with the minimum cost calculated by the cost function among routes that pass through some or all of the relay points in the network to satisfy the constraint conditions.

2. The route design system according to claim 1, wherein the processor is configured to execute the instructions to output the route designed by seeking a combination of relay points that minimizes a total cost based on the cost incurred when moving from one candidate relay point to another candidate relay point.

3. The route design system according to claim 1, wherein the processor is configured to execute the instructions to:
learn a first cost function which is a cost function that calculates a cost incurred in selecting the candidate relay point;
learn a second cost function which is a cost function that calculates a cost incurred in designing a route;
select a candidate relay point with the minimum cost calculated by the first cost function; and
output the route with the minimum cost calculated by the second cost function.

4. The route design system according to claim 1, wherein the processor is configured to execute the instructions to:
accept input of a list of relay points that are candidates to be selected as constraint conditions; and
select the candidate relay point from the received list.

5. The route design system according to claim 1, wherein the processor is configured to execute the instructions to:
accept input of information indicating a range of a network where the relay point can be set as a constraint condition, and
select the candidate relay point from the range of the network which is input.

6. The route design system according to claim 1, wherein the processor is configured to execute the instructions to output each relay point included in the designed route and the route connecting each the relay point superimposed on a map.

7. The route design system according to claim 1, wherein the processor is configured to execute the instructions to output a correspondence between a feature included in the cost function and the degree of importance of the feature.

8. The route design system according to claim 1, wherein the processor is configured to execute the instructions to learn the cost function that includes at least one of the number of users and satisfaction level as a feature.

9. A cost function learning device comprising:
a memory storing instructions; and
one or more processors configured to execute the instructions to:
accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route; and
learn the cost function by inverse reinforcement learning using training data that includes relay point information which is data that maps information indicating a relay point with surrounding information of the relay point and usage information of the relay point, and route result information which is result data of a route that pass through each relay point.

10. A designed route output device comprising:
a memory storing instructions; and
one or more processors configured to execute the instructions to:
accept input of a cost function that calculates a cost incurred in at least one of a selection of a candidate relay point and a design of a route, the cost function being represented as a linear sum of terms weighted by degree of importance attached to each of the features that an expert is assumed to intend when selecting the candidate relay point and design of the route, relay point information which is data that maps information indicating a relay point with surrounding information of the relay point and usage information of the relay point for a network for which a new route design is to be performed, and a constraint condition;
select, based on the input relay point information, the candidate relay point with the minimum cost calculated by the cost function to satisfy the input constraint conditions;
output the route with the minimum cost calculated by the cost function among routes that pass through some or all of the relay points in the network to satisfy the constraint conditions; and
accept input of the cost function learned by inverse reinforcement learning using training data that includes the relay point information and route result information which is result data of a route that pass through each relay point.

11. (canceled)

12. (canceled)

13. (canceled)

14. (canceled)

15. (canceled)
